(19) United States
(12) Patent Application Publication
(10) Pub. No.: US 2008/0222660 A1
(43) Pub. Date: Sep. 11, 2008

(54) Processing of data of a plurality of applications with a single client application

(76) Inventors: Jari Tavi, Espoo (FI); Joonas Koskela, Espoo (FI); Auvo Severinkangas, Espoo (FI)

Correspondence Address: ARENT FOX LLP, 1050 CONNECTICUT AVENUE, N.W., SUITE 400, WASHINGTON, DC, 20036, US

(21) Appl. No.: 11/714,270

(22) Filed: Mar. 6, 2007

(51) Int. Cl. G06F 9/46

(52) U.S. Cl. 719/320

(57) ABSTRACT

The present invention is directed to a method, a system, an interface entity, and a client application for processing data of a plurality of applications in a single client application.

### BACKGROUND OF THE INVENTION

1. Field of the Invention

The present invention is directed to a method, a system, an interface entity, and a client application for processing data of a plurality of applications in a single client application.

2. Description of Related Art

Workflow based or process-oriented applications typically generate tasks that need to be completed in order for processing of a case to continue in such application. Cases that are processed in the application may pass through various stages or have different statuses during the course of processing. For example, a case may have a status of ‘waiting for approval’, and continued processing of the case requires that a party authorized to approve the phase in question performs the task of approving the phase and returns information on said approval back to the application. Examples of such applications and tasks are entry, review, and approval of documents in a document management application, review and approval of purchase orders in a purchase order management application, entry, review and approval of purchase invoices in an invoice management application, and entry, review, and modification of customer contacts in a customer relationship management application.

Large companies and entities thereof typically employ extensive backend systems that run several applications of the type described above. Some functions, such as purchase order and invoice management, may be integrated into large-size applications together with other functions, such as indication of inspection and approval of received goods.

Users of the backend system applications access the applications, process data and perform tasks in the applications by means of client applications that run on user devices, such as desktop or laptop computers, personal digital assistants (PDAs), or wireless or mobile devices, such as mobile phones. Client applications access the applications through application interfaces, and if a user device is utilized for accessing and using a plurality of applications, it typically stores and runs a dedicated client application for each of the applications, i.e. a corresponding number of client applications is needed on the client side as is the number of applications on the backend system side.

As mobile devices in particular have limited data processing and storage capacity, it would be useful if multiple applications that are run in a backend system could be accessed and used with one single client application. This need may be met to a certain extent by employing so called thin clients. A thin client may be for example a web browser that accesses and uses a number of backend system applications through an HTML interface implemented in or arranged to communicate with the applications such that each application has its respective HTML interface. Client functions required to process data of the applications may be effected by program code run in the browser or on the server where the HTML interface is implemented. Some applications may even be accessed and used through an interface that is operated by commands sent in plain text format from a text-messaging application, such as an e-mail client application or a short message (e.g. SMS) application.

Attempts to use workflow based or process-oriented applications, where cases that are processed in said applications have a process status attached thereto that changes in the course of processing, with web browsers or messaging applications, such as e-mail clients, have not produced satisfactory results. Web browser based client applications are not able to handle offline use, where a user e.g. first retrieves his tasks from an application when he is online, processes the tasks offline, and wants to return the processed results back to the application when he is online again. E-mail based clients and systems would be very complicated to implement and would be in any case limited to the particular e-mail application, i.e. the client application would not be generic.

### SUMMARY OF THE INVENTION

As a first aspect the invention provides a method for enabling use of a plurality of applications by means of a single generic client application, wherein the method comprises the steps of receiving content data and description data from a first application of the plurality of applications, receiving at least one processing rule from a processing rule provider, wherein the at least one processing rule is associated with processing data in said first application, composing a first process contract, wherein the first process contract comprises the content data, process status data, object type data, and at least one processing instruction, wherein the process status data and the object type data are determined by the description data, and the least one processing instruction is determined by the at least one processing rule, and making the first process contract available for delivery to the client application, wherein the first process contract is arranged to adapt the client application for interacting with the first application.

According to the method, content data and description data may further be received from a second application of the plurality of applications, and a second process contract may be composed for said second application. Further processing rules may be received, wherein said further processing rules are associated with processing data in said second application.

According to an embodiment of the invention the first process contract is delivered to the client application by means of a distribution service, such as a web service. According to another embodiment the first process contract is provided to a proxy for delivery to the client application. The proxy may be arranged to modify the first process contract such that only necessary portions of the process contract are delivered to the client application. The proxy may also be configured to receive device capability information from the client application and to modify the first process contract on the basis of the capability information.

In a further embodiment of the invention the first process contract is a structured document.

As a second aspect the invention provides a method for processing data originating from a plurality of applications by means of a single generic client application, wherein the method comprises the steps of receiving a first process contract by the client application, wherein the process contract comprises content data from a first application of the plurality of applications, process status data, object type data, and at least one processing instruction, interpreting the at least one processing instruction by the client application, wherein the at least one processing instruction determines how the data included in the first process contract is processed in the client application, and processing the data included in the first process contract by means of the client application according to the at least one processing instruction.

According to the method, a second process contract may be received, wherein the second process contract comprises content data from a second application of the plurality of applications.

According to an embodiment of the invention, a first portion of the first process contract is received from a proxy and a second portion of the first process contract is received from a memory means accessible to the client application. The first portion and the second portion of the first process contract may be combined to form a complete first process contract.

According to another embodiment of the invention, processing of data included in the first process contract comprises presenting, by means of a user interface, to a user at least the content data included in the first process contract and actions said user is allowed to perform on the content data, wherein the allowed actions are determined by the at least one processing instruction.

According to an alternative embodiment, processing of data included in the first process contract comprises sending commands to another application, wherein the commands are determined by the at least one processing instruction.

In a further embodiment of the invention, data included in the first process contract is processed by a decision logic portion of the client application, wherein the decision logic portion is arranged to enable processing of the data according to the at least one processing instruction, and wherein the decision logic portion is extensible with software program code adapted to enable processing of data according to new processing instructions.

As a third aspect the invention provides a method for providing data from a single generic client application to a plurality of applications by means of a process contract, the method comprising the steps of selecting a first application from the plurality of applications by means of the client application, selecting the type of a first process contract to be composed, receiving a first process contract template corresponding to the type of the first process contract to be composed, composing the first process contract by the client application by using the first process contract template, and sending the first process contract to the selected first application, wherein the first process contract comprises data to be provided to the selected first application.

The method may further comprise the steps of selecting a second application from the plurality of applications, selecting the type of a second process contract to be composed, receiving a second process contract template corresponding to the type of the second process contract to be composed, composing the second process contract by the client application by using the second process contract template, and sending the second process contract to the selected second application, wherein the second process contract comprises data to be provided to the second application.

In an embodiment of the invention the first process contract template is received by retrieving said template from a memory means accessible to the client application. In an alternative embodiment the first process contract template is received as a response to a request for said template sent to a contract template provider.

As a fourth aspect the invention provides an interface entity for enabling use of a plurality of applications by means of a single generic client application, wherein the interface entity comprises a collector component arranged to receive content data and description data from a first application of the plurality of applications, and a producer component arranged to receive the content data and the description data from the collector component and at least one processing rule from a processing rule provider, wherein the at least one processing rule is associated with processing data in the first application, to compose a first process contract, wherein the first process contract is a structured document comprising the content data, process status data, object type data, and at least one processing instruction, wherein the process status data and the object type data are determined by the description data, and the least one processing instruction is determined by the at least one processing rule, and to make the first process contract available for delivery to the client application, wherein the first process contract is arranged to adapt the client application for interacting with the first application.

The collector component may further be arranged to receive content data and description data from a second application of the plurality of applications and a further processing rule from the processing rule provider, wherein the further processing rule is associated with processing data in the second application, to compose a second process contract, and to make the second process contract available for delivery to the client application, wherein the second process contract is arranged to adapt the client application for interacting with the second application.

As a fifth aspect the invention provides a generic client application for processing data of a plurality of applications, wherein the client application comprises a general logic component arranged to receive a process contract and to provide the process contract to an interpreter component, said interpreter component arranged to interpret at least one processing instruction, wherein the at least one processing instruction is included in the process contract, and a decision logic component arranged to enable processing of data included in the process contract according to the at least processing instruction.

According to an embodiment of the invention the general logic component is arranged to receive a first portion of the process contract from a proxy and a second portion of the process contract from a memory means accessible to the general logic component, and to combine the first portion and the second portion to form a complete process contract.

According to another embodiment the decision logic component is arranged to present, by means of a user interface, to a user at least content data included in the process contract and actions said user is allowed to perform on the content data, wherein the allowed actions are determined by the at least one processing instruction.

In an alternative embodiment the decision logic component is arranged to send commands to another application, wherein the commands are determined by the at least one processing instruction.

According to an alternative embodiment the general logic component is further arranged to receive a process contract template, wherein the template is used for composing a new process contract. In an embodiment of the invention the general logic component is arranged to receive the process contract template as a response to a request for a template sent to a process contract template provider. According to another embodiment the general logic component is arranged to receive the process contract template by retrieving it from a memory means accessible to the general logic component.

In one embodiment of the invention the general logic component is arranged to pass on the process contract template to the decision logic, wherein the decision logic is arranged to present the template to a user by means of a user interface.

As a further aspect the invention provides a device, which comprises a generic client application according to the fifth aspect.

As another aspect the invention provides a system for processing data of a plurality of applications by means of a single generic client application, wherein the system comprises said plurality of applications, a processing rule provider, an interface entity according to the fourth aspect of the invention, and a client application according to the fifth aspect of the invention.

In an embodiment of the invention the system comprises a process contract template provider.

In the following a preferred embodiment and other advantageous embodiments of the present invention are explained in detail with reference to the appended drawings. A person skilled in the art appreciates that the embodiments are described for illustrative purposes only and are not intended to limit the scope of the claims to said embodiments. A skilled person also appreciates that an aspect of the invention may be used in combination of one or more of the disclosed embodiments.

### BRIEF DESCRIPTION OF THE DRAWINGS

FIG. 1 depicts an example of a system employing the present invention.

FIG. 2 depicts an example of a client application structure according to the present invention.

### DETAILED DESCRIPTION OF EMBODIMENTS

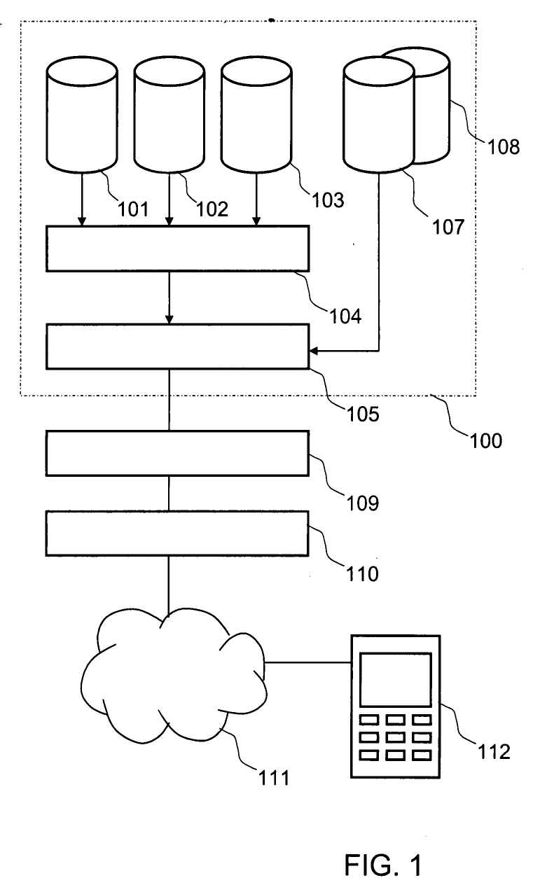

FIG. 1 shows in outline a combination of systems and elements, wherein the present invention may be employed. The combination comprises a backend system 100, which involves a plurality of backend system applications 101, 102, 103. Three applications are shown in FIG. 1, but a skilled person appreciates that the number of the applications may vary in different implementations and is determined by e.g. specific needs of an individual organisation.

The present invention is especially useful if the applications 101, 102, 103 are workflow based or process-oriented applications that represent business processes, where tasks are generated for individuals who e.g. are in charge of completion of a particular process phase, but in principle the invention can be used in conjunction with any type of application.

FIG. 1 shows further a collector component 104 and a producer component 105 according to the present invention. Both components may be implemented as computer programs or computer program components. In some embodiments of the invention at least a portion of the functionality of the components may be implemented in hardware module(s).

In the embodiment of the invention shown in FIG. 1 the components are presented as part of the backend system 100, but the components may also be implemented and reside outside the backend system 100. For example, each component may reside and run on a server of its own, wherein each server is arranged to be in communication with the applications 101, 102, 103 of the backend system 100.

FIG. 1 further depicts a processing rule provider 107 and a process contract template provider 108. Like the collector and producer components 104 and 105, also the processing rule provider 107 and the contract template provider 108 may be implemented as computer programs or computer program components. In some embodiments of the invention at least a portion of the functionality of the provider elements may be implemented in hardware module(s). Similarly, the processing rule provider 107 and the process contract template provider 108 may reside on a server outside the backend system 100, or each provider element on a server of its own. In such implementations the server(s) need to be in communication with at least the producer component 104.

The embodiment of FIG. 1 also comprises a web service component 109 and a user device 112, which is arranged to run a client application according to the present invention. The user device 112 may also be referred to by the term ‘user terminal’. The user terminal 112 communicates with the web service component 109 over a network 111 preferably in a secure manner, for example by using a secure communication protocol, such as HTTPS.

A skilled person appreciates that secure communication with HTTPS protocol is implemented e.g. by encrypting HTML application data in transport layer and that said communication requires a number of lower layer protocols, such as TCP and IP as well as data link layer and physical layer protocols depending on the employed transmission media in the network 111. Such protocols and medias are not described further herein, as they are known to a person skilled in the art.

In some embodiments of the invention the user device 112 may be a mobile device. In such embodiments the user device 112 communicates with the web service component preferably via a proxy 110 due to e.g. information security reasons. In an embodiment of the invention the proxy 110 also has a role in network traffic optimization, as will be described later.

A person skilled in the art appreciates that even though the web service component 109 and the proxy 110 are shown as separate entities residing outside the backend system 100, they can both reside on a same server outside the backend system 100, or they can reside in and be implemented as part of the backend system 100. What is said above about the location and implementation of the collector component 104, producer component 105, processing rule provider 107, and the process contract template provider 108, also applies to the web service component 109 and the proxy 110. A skilled person has a number of options available for implementing and placing said components and elements.

The collector component 104 is arranged to receive content data from the applications 101, 102, 103. The content data may be for example the content portion of a purchase order document, which is processed in a purchase management application. The applications 101, 102, 103 may employ a proprietary or standard format for documents that are processed in said application. If the applications 101, 102, 103 use a proprietary format, at least the content portion is preferably converted into a generic format, such as text, by the application 101, 102, 103 or the collector component 104.

The collector component also receives description data from the applications 101, 102, 103. The description data may comprise a description of the content data and a process status of the document or the case that the document pertains to. For example, the description data may comprise a description of the content data type, such as ‘purchase invoice’ and a timestamp indicating, when the content data and the description data items were generated in the application and/or forwarded to the collector component 104. The description data may also comprise an indication or a code word indicating that a document has a status of ‘reviewed, waiting for approval’, or that a purchase order has a status of ‘review purchase invoice’. The description data may be part of the same document as the content data, or be stored and processed as a separate document. Similarly to the content data, the description data may be in a proprietary format employed by the application 101, 102, 103. In that case the description data is preferably converted into a generic format, such as text, by the application 101, 102, 103 or the collector component 104.

Even though documents and cases may have similar statuses in the applications 101, 102, 103, the applications may use different indications and/or codewords for describing said statuses. For example, application 101 may use the expression ‘waiting for approval’ in its description data to indicate said status, meanwhile application 102 may use e.g. number ‘1’ for the same purpose. In an embodiment of the invention the collector component 104 normalizes description data from different applications 101, 102, 103 such that the collector component uses the same indication and/or codeword for the same process status, even though the data, which the process status pertains to, originates from different applications 101, 102, 103.

The collector component 104 may receive content data and description data from the applications 101, 102, 103 in push mode, pull mode, or both, i.e. the collector component 104 may request said data from the applications 101, 102, 103 at intervals or when triggered by a particular event, such as a request received from a client application of the user device 112, or the applications 101, 102, 103 may send said data to the collector component 104 at intervals or when triggered by an event, such as a change in process status or registration of a client application into the system.

The collector component 104 forwards the content data and the description data received from the applications 101, 102, 103 to the producer component 105. In some embodiments of the invention the collector component may modify said data before forwarding them to the producer component 105 e.g. in a manner described hereinbefore.

The producer component 105 receives the content data and the description data from the collector component 104. In addition, the producer component 105 receives a set of processing rules from a processing rule provider 107. Said set of processing rules comprises a suitable number of processing rules that are associated with processing data in the applications 101, 102, 103 and determine how the content data and the description data may be processed e.g. on the user device 112. In other words, the processing rules pertain to the stage at which the content data and/or the case or document it relates to are in the process that is implemented in the applications 101, 102, 103 and are determined by said stage and allowed actions in said stage. For example, if the content data item is a purchase invoice that is in the stage of waiting for approval, the processing rules may determine that the content data may be reviewed or approved.

The processing rule provider 107 stores and delivers to the producer component 105 processing rules that are associated with particular content and description data items originating from each of the applications. In other words, each of the applications 101, 102, 103 may have specific processing rules stored in the processing rule provider 107, which forwards the required processing rules to the producer component 105 when content and description data items have been received from that particular application by the producer component 105. Some of the processing rules stored in the processing rule provider 107 may also be common to all of the applications 101, 102, 103.

In FIG. 1 the processing rule provider 107 is shown as a separate entity, but it may also be implemented e.g. in each of the applications 101, 102, 103 such that each of the applications has a processing rule provider component of its own. The producer component 105 receives the processing rules from the processing rule provider 107, as well as the content data and description data items from the collector component 104 via a suitable delivery means, such as a memory location of a memory means, system internal bus, or a wired or wireless communication connection. The producer component 105 may receive said rules and data in pull or push mode, or both in a similar manner as described in connection with the collector component 104.

Once the producer component 105 has the content data and description data items as well as the set of processing rules at its disposal, it composes a process contract by utilizing said data items and processing rules. In the context of the present application a process contract is to be understood as a document item/instance comprising a content portion, a description portion, and an instruction portion. For example, the content part of the process contract may contain the content of a purchase invoice from a purchase management system, the description part may contain identification and timestamp information as well as information on the process status of the purchase invoice in the invoice management system, and the instruction part may contain instructions as to how the data contained in the process contract may be processed. The designations of said portions may vary.

The process contract of the present invention is preferably a structured document instance, for example an XML document instance, as a structured document provides efficient means for identifying different parts of the document and their relationships by means of a suitable markup, but the process contract may also be of other type, even a flat file. In that case, the logic for identifying different parts of the document and their relationships needs to be implemented e.g. in the user device 112 by means of a suitable computer program code.

The composed process contract comprises the content data received from the applications 101, 102, 103, process status data, object type data, and at least one processing instruction. The object type data and process status data is determined by the description data received from the applications 101, 102, 103, in particular those portions of the data that comprise information on the content data type and process status of the content data in the applications 101, 102, 103. The content data and the process status data are included in the process contract in a suitable form. They may be included in the same form as they were received from the applications 101, 102, 103, or they may be modified by e.g. the collector component 104 or the producer component 105 as described hereinbefore.

The at least one processing instruction is determined by the processing rules received from the processing rule provider 107. The term ‘processing instruction’ is to be understood in the context of the present application as directions that determine actions and/or tasks that are allowed to be performed on the process contract or data contained therein, for example the content data or the process status data. The processing instructions of the present information may also comprise graphical user interface (GUI) elements that are determined by the allowed actions. The term is not to be construed as meaning e.g. control commands for applications or devices, such as those used in SGML or XML. Nor is the term to be construed as computer program code instructions, such as JavaScript instructions, that may be included in an HTML page.

The composed process contract is then delivered to a client application provided by the present invention. The client application may be stored and run on the user device 112. The process contract adapts the client application of the present invention for interacting with the applications 101, 102, 103 such that said one generic client application can interact with each of the applications 101, 102, 103. By interacting with the applications it is meant that the client application is able to e.g. process information that originates from the applications and is able to generate information that can be delivered to the applications and processed further therein.

The producer component 105 preferably produces dedicated process contracts for each of the applications 101, 102, 103, even though it is possible to use one process contract for events originating from two or more applications. A process contract may comprise multiple tasks originating from one of the applications 101, 102, 103 and assigned to a user of the user device 112. For example, if the user has a plurality of purchase invoices that he needs to review and/or approve, the collector component 104 may receive the content data and description data of all invoices, and the producer component 105 may compose a single process contract that corresponds to all said invoices. But if the user is assigned a plurality of tasks from at least two of the applications 101, 102, 103, the producer component 105 preferably composes own process contracts for each application, wherein each process contract may comprise multiple tasks from the same application as described above. With separate process contracts for each application it is easier to launch and manage multiple instances of the client application in the user device 112, thereby providing the user with a feeling of having a dedicated client application for each application 101, 102, 103. It may also be useful to compose separate process contracts for multiple events from the same application, if the events require different type of processing and therefore different processing instructions.

The process contract may be delivered to the user device 112 and thereby to the client application by means of an appropriate distribution service, such as a web service 109, an FTP service, a database or the like. If the user device is a mobile device, the communication to and from the user device 112 is preferably handled through a proxy 110.

The proxy 110 may be arranged to modify the process contract such that only necessary portions of the process contract is delivered to the user device 112. For example, a task may be generated for a user in one of the applications 101, 102, 103, and a corresponding process contract is composed and delivered to the user device 112. The user may perform an allowed action on the process contract representing the task and may thereby change the process status of the case that the task pertains to. The user sends the process contract back to the originating application for further processing. Another user may perform another action, after which a new task may be generated to the first user. When a new process contract is composed and sent to the user device 112, the proxy 110 may compare the new process contract to the previous process contract, and forward to the user device 112 only those portions of the new process contract that have been changed as compared with the previous one, together with identification information such that the user device 112 is able to associate the new process contract with the previous process contract stored in the user device 112 and substitute the changed portions for previous portions, i.e. the user device constructs a complete process contract by combining the changed portion with the unchanged portion of the process contract.

The proxy 110 may also receive device capability information, such as information on display size, position of keys and the like, from the user device 112 and modify the process contract on the basis of said device capability information before delivering the process contract to the user device 112.

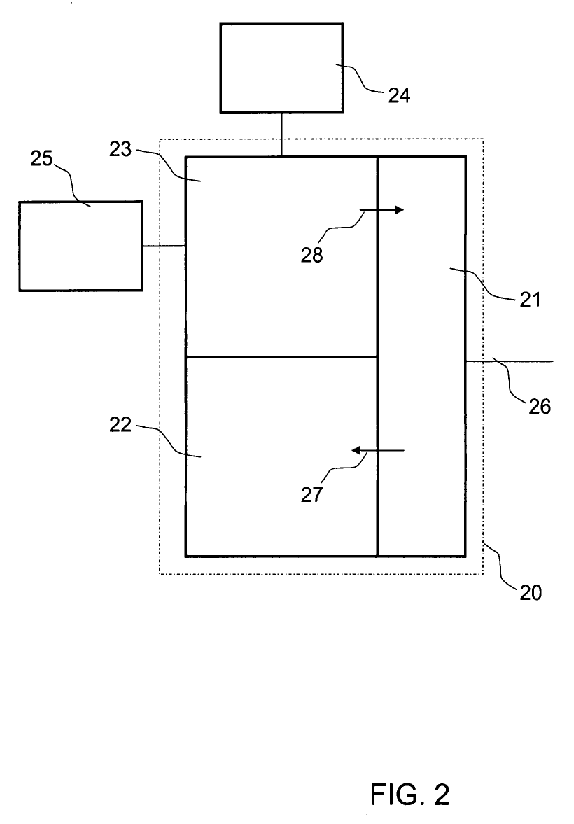

Reference is now made to FIG. 2. FIG. 2 shows an example of the structure of the client application 20 according to the present invention. The client application 20 comprises a general logic component 21, an interpreter component 22, and a decision logic component 23. The decision logic component may interface with a graphical user interface (GUI) component 24 and an external application 25. FIG. 2 shows the components 21, 22, and 23 as separate entities, but the components may also be included in one entity, for example in the form of program code portions in a computer program, or two components may be included in one entity, and one component included in another entity. The components 21, 22, and 23 may be implemented in software or hardware or in combinations thereof depending on the embodiment. In software implementation, program code corresponding to the components may be executed in a central processing unit of a computer or in a baseband processor of a mobile device.

The general logic component 21 is configured to communicate with the backend system applications over a communication connection 26, which may be wired or wireless connection. The general logic component 21 is further configured to receive a process contract according to the present invention. The general logic component may receive a portion of the process contract from a proxy and another portion from a memory means accessible to the general logic portion 21 in a manner described hereinbefore. The general logic components is further configured to forward 27 the process contract to the interpreter component 22.

As described hereinbefore, the process contract comprises at least one processing instruction that determines how the data contained in the process contract may be processed in the client application, for example by the decision logic component 23. The interpreter component 22 is configured to interpret the processing instructions, thereby determining actions that are allowed to be performed on the data included in the process contract, and/or control commands for controlling the external application 25, and to forward said instructions, control commands, and/or allowed actions to the decision logic component 23 in a format readable by said component. The interpreter component also forwards at least the content data and process status data portions of the process contract to the decision logic component 23.

In a preferred embodiment of the invention the process contract is a structured document instance, such as an XML document instance, which comprises information elements that controls the decision logic component 23 in building a user interface by means of the GUI component 24. For example, the process contract may comprise GUI elements representing allowed actions in the form of XML elements, and attributes attached to the GUI XML elements representing the appearance, position etc. of the GUI elements on a display. As described hereinbefore, the GUI XML elements and their attributes may be modified by a proxy on the basis of device capability information that the client application, for example the general logic component 21 sends to the proxy.

The decision logic component 23 may be configured to present the content data and process status data included in the process contract, and the actions that are allowed on the content and/or process status data in a suitable format. For example, the allowed actions may be presented as push buttons, and the user may complete his task by clicking an appropriate button by means of a pointing device on the user device 112.

Once the user has performed his task and indicated completion thereof e.g. by clicking a corresponding button in the GUI, the decision logic component 23 modifies the corresponding portions of the process contract. For example, if the user has reviewed and approved a purchase invoice, the decision component modifies the process status data included in the process contract. If the user reviewed a document and approved it after making some amendments to it, the decision logic component incorporates the amendments into the content portion of the process contract and modifies the process status data accordingly. After completing the modifications, the decision logic component 23 forwards 28 the modified process contract to the general logic component 21, which forwards it to the backend systems. Preferably, the general logic component also stores the modified process contract to a memory means accessible to the general logic component 21 such that unmodified portions of the process contract can be retrieved from said memory means if needed, as described earlier.

The decision logic component 23 may also interface with an external application 25, and control said external applications by control commands determined by the processing instructions included in the process contract. The control messages comprising the control commands may employ an open, generic format, such as XML.

The decision logic component 23 of the client application 20 may be extensible with software program code such that e.g. new program code corresponding to new processing instructions can be added to the decision logic component 23. The new processing instructions are determined by e.g. new processing rules added to the processing rule provider 107 of FIG. 1. This feature provides a convenient way for adding new functionality to the client application 20.

As described earlier, the client application may receive and process in a manner described above a plurality of process contracts representing a plurality of applications. Process contracts representing different applications may be used to control respective instances of the client applications such that each client application may provide a different ‘look and feel’ for a user, thereby creating an impression that a user device comprises a dedicated client application for each backend system application.

If a user wants to access a backend system application by means of the generic client application 20, he first starts the application. Once the application has started, the user may be presented with a task list in the form of a dialog or the like, where the user can select the tasks he wants to complete. The dialog and a generic GUI, as well as a GUI representing each backend system application in the client application 20 may be generated by the decision logic component 23 and the GUI component 24. Once the user has selected the task(s) that he wants to complete, the GUI of the client application 20 may change under the control of the decision logic component 23 and the GUI component 24 to represent the corresponding backend system application. The application GUI may present, e.g. in the form of dialog elements, such as push buttons, actions that are available to the user. The user may e.g. select to retrieve his pending tasks from the application, after which the data retrieval proceeds as described hereinbefore.

Another possibility is that the user interface of a user device comprises a number of icons such that each backend system application is represented by an icon in the user interface of the user device. When the user wants to access certain backend application, he may click the corresponding icon, which causes the client application of the present invention to start, and possibly also load some settings and initial data relating to the backend application.

If the user wants to create a new data item, such as a new document or a new customer contact card, to be entered into the application, the user may first select the type of the data item to be created in the application GUI. The user's selection of the data item type triggers the general logic component 21 of the client application 20 to retrieve a corresponding process contract template, as the data to be created will be delivered to the backend system application by means of the process contract of the present invention. The general logic component 21 may retrieve the process contract template from a memory means accessible to the general logic component 21, or it may send a request for a process contract template to a process contract template provider 108 of FIG. 1 and receive the process contract template as a response to said request.

The general logic component 21 forwards the process contract template to the decision logic component 23, possibly via the interpreter component 22, if the process contract template comprises processing instructions that the interpreter component 22 needs to interpret for the decision logic 23. The decision logic component 23 presents the process contract template to the user by means of the GUI component 24, after which the creation and sending of the process contract representing the new data item proceeds in a similar manner as that described hereinbefore in connection with processing of a received process contract in the client application 20.

The client application 20 may create different types of process contracts for different applications and/or for different data items, as is apparent for a person skilled in the art on the basis of the description of the invention contained herein.

The detailed description of embodiments of the present invention is presented for purposes of illustration and description. It is not intended to be exhaustive or to limit the scope of protection defined by the claims appended hereto to the described embodiments.

1. A method for enabling use of a plurality of applications by means of a single client application, wherein the method comprises the steps of:
receiving content data and description data from a first application of the plurality of applications;
receiving at least one processing rule from a processing rule provider, wherein the at least one processing rule is associated with processing data in said first application;
composing a first process contract, wherein the first process contract comprises the content data, process status data, object type data, and at least one processing instruction, wherein the process status data and the object type data are determined by the description data, and the least one processing instruction is determined by the at least one processing rule; and
making the first process contract available for delivery to the client application, wherein the first process contract is arranged to adapt the client application for interacting with the first application.

2. A method according to claim 1, wherein the method further comprises receiving content data and description data from a second application of the plurality of applications and composing a second process contract for said second application.

3. A method according to claim 2, wherein the method further comprises receiving at least one further processing rule, wherein said further processing rule is associated with processing data in said second application.

4. A method according to claim 2, wherein the method further comprises the step of normalizing the description data received from the first application and the second application such that similar conditions in the first and the second applications are represented by similar portions of the normalized description data.

5. A method according to claim 1, wherein the method further comprises the step of delivering the first process contract to the client application by means of a distribution service, such as a web service.

6. A method according to claim 1, wherein the method further comprises the step of providing the first process contract to a proxy for delivery to the client application.

7. A method according to claim 6, wherein the proxy is arranged to modify the first process contract such that only necessary portions of the process contract are delivered to the client application.

8. A method according to claim 7, wherein the proxy is configured to receive device capability information from the client application and to modify the first process contract on the basis of the device capability information.

9. A method according to claim 1, wherein the first process contract is a structured document.

10. A method for processing data originating from a plurality of applications by means of a single client application, wherein the method comprises the steps of:
receiving a first process contract by the client application, wherein the process contract comprises content data from a first application of the plurality of applications, process status data, object type data, and at least one processing instruction;
interpreting the at least one processing instruction by the client application, wherein the at least one processing instruction determines how the data included in the first process contract is processed in the client application;
processing the data included in the first process contract by means of the client application according to the at least one processing instruction.

11. A method according to claim 10, wherein the method further comprises receiving a second process contract, which comprises content data from a second application of the plurality of applications.

12. A method according to claim 10, wherein the method comprises receiving a first portion of the first process contract from a proxy and a second portion of the first process contract from a memory means accessible to the client application.

13. A method according to claim 12, wherein the method comprises combining the first portion and the second portion of the first process contract to form a complete first process contract.

14. A method according to claim 10, wherein the processing of the data included in the first process contract comprises presenting, by means of a user interface, to a user at least the content data included in the first process contract and actions said user is allowed to perform on the content data, wherein the allowed actions are determined by the at least one processing instruction.

15. A method according to claim 10, wherein the processing of the data included in the first process contract comprises sending commands to another application, wherein the commands are determined by the at least one processing instruction.

16. A method according to claim 10, wherein the method comprises processing the data included in the first process contract by a decision logic portion of the client application, wherein the decision logic portion is arranged to enable processing of the data according to the at least one processing instruction, and wherein the decision logic portion is extensible with software program code adapted to enable processing of data according to new processing instructions.

17. A method for providing data from a single client application to a plurality of applications by means of a process contract, the method comprising the steps of:
selecting a first application from the plurality of applications by means of the client application;
selecting the type of a first process contract to be composed;
receiving a first process contract template corresponding to the type of the first process contract to be composed;
composing the first process contract by the client application by using the first process contract template;
sending the first process contract to the selected first application, wherein the first process contract comprises data to be provided to the selected first application.

18. A method according to claim 17, wherein the method further comprises the steps of:
selecting a second application from the plurality of applications;
selecting the type of a second process contract to be composed;
receiving a second process contract template corresponding to the type of the second process contract to be composed;
composing the second process contract by the client application by using the second process contract template;
sending the second process contract to the selected second application, wherein the second process contract comprises data to be provided to the second application.

19. A method according to claim 17, wherein the first process contract template is received by retrieving said template from a memory means accessible to the client application.

20. A method according to claim 17, wherein the first process contract template is received as a response to a request for said template sent to a contract template provider.

21. An interface entity for enabling use of a plurality of applications by means of a single client application, wherein the interface entity comprises:
a collector component arranged to receive content data and description data from a first application of the plurality of applications; and
a producer component arranged to receive the content data and the description data from the collector component and at least one processing rule from a processing rule provider, wherein the at least one processing rule is associated with processing data in the first application, to compose a first process contract, wherein the first process contract is a structured document comprising the content data, process status data, object type data, and at least one processing instruction, wherein the process status data and the object type data are determined by the description data, and the least one processing instruction is determined by the at least one processing rule, and to make the first process contract available for delivery to the client application, wherein the first process contract is arranged to adapt the client application for interacting with the first application.

22. An interface entity according to claim 21, wherein the collector component is further arranged to receive content data and description data from a second application of the plurality of applications and a further processing rule from the processing rule provider, wherein the further processing rule is associated with processing data in the second application, to compose a second process contract, and to make the second process contract available for delivery to the client application, wherein the second process contract is arranged to adapt the client application for interacting with the second application.

23. An interface entity according to claim 22, wherein the collector component is further arranged to normalize the description data received from the first application and the second application such that similar conditions in the first and the second applications are represented by similar portions of the normalized description data.

24. A client application for processing data of a plurality of applications, wherein the client application comprises:
a general logic component arranged to receive a process contract and to provide the process contract to an interpreter component;
said interpreter component arranged to interpret at least one processing instruction, wherein the at least one processing instruction is included in the process contract; and
a decision logic component arranged to enable processing of data included in the process contract according to the at least processing instruction.

25. A client application according to claim 24, wherein the general logic component is arranged to receive a first portion of the process contract from a proxy and a second portion of the process contract from a memory means accessible to the general logic component, and to combine the first portion and the second portion to form a complete process contract.

26. A client application according to claim 24, wherein the decision logic component is arranged to present, by means of a user interface, to a user at least content data included in the process contract and actions said user is allowed to perform on the content data, wherein the allowed actions are determined by the at least one processing instruction.

27. A client application according to claim 24, wherein the decision logic component is arranged to send commands to another application, wherein the commands are determined by the at least one processing instruction.

28. A client application according to claim 24, wherein the general logic component is further arranged to receive a process contract template, wherein the template is used for composing a new process contract.

29. A client application according to claim 28, wherein the general logic component is arranged to receive the process contract template as a response to a request for a template sent to a process contract template provider.

30. A client application according to claim 28, wherein the general logic component is arranged to receive the process contract template by retrieving it from a memory means accessible to the general logic component.

31. A client application according to claim 28, wherein the general logic component is arranged to forward the process contract template to the decision logic, wherein the decision logic is arranged to present the template to a user by means of a user interface.

32. A device comprising a client application according to claim 24.

33. A system for processing data of a plurality of applications by means of a single client application, wherein the system comprises:
said plurality of applications,
a processing rule provider,
an interface entity according to claim 21,
a client application according to claim 24.

34. A system according to claim 33, wherein the system further comprises a process contract template provider.
